(19) United States
(12) Patent Application Publication
(10) Pub. No.: US 2017/0222331 A1
(43) Pub. Date: Aug. 3, 2017

(54) MULTIPLE-INPUT, MULTIPLE-OUTPUT ANTENNA WITH CROSS-CHANNEL ISOLATION USING MAGNETO-DIELECTRIC MATERIAL

(71) Applicant: Rogers Corporation, Rogers, CT (US)

(72) Inventors: Kristi PANCE, Auburndale, MA (US); Karl E. SPRENTALL, Scottsdale, AZ (US)

(21) Appl. No.: 15/500,996

(22) PCT Filed: Aug. 19, 2015
(86) PCT No.: PCT/US2015/045854

§ 371 Date: Feb. 1, 2017

Related U.S. Application Data
(60) Provisional application No. 62/039,993, filed on Aug. 21, 2014.

(51) Int. Cl. H01Q 21/06; H01Q 1/48; H01Q 1/52; H01Q 21/00; H01Q 1/24

(52) U.S. Cl. CPC H01Q 21/065; H01Q 21/0068; H01Q 1/246; H01Q 1/523; H01Q 1/48

(57) ABSTRACT

An antenna assembly includes a dielectric layer having a upper side and a lower side, a ground plane disposed on the lower side of the dielectric layer, two antenna elements supported by and disposed on the upper side layer of the dielectric layer and a magneto-dielectric disposed between the two antenna elements.

### BACKGROUND

1. Field of the Invention

Embodiments disclosed herein relate to telecommunications systems and, in particular, to a MIMO (Multiple-Input, Multiple-Output) antenna system with cross channel isolation.

2. Related Art

The increased adoption of higher data-rate communications standards, such as LTE (Long-Term Evolution) cellular and IEEE 802.11n (and above) Wi-Fi systems has led to an increased requirement for MIMO (Multiple-Input, Multiple-Output) antenna systems, both within and external to, base-station or access point equipment.

A MIMO antenna includes two or more separate antennas. There are several different manners in which a MIMO antenna system may be operated. First, Precoding is multi-stream beamforming spatial processing that occurs at the transmitter. In (single-stream) beamforming, the same signal is emitted from each of the transmit antennas with appropriate phase and gain weighting such that the signal power is maximized at the receiver input. Second, in spatial multiplexing, a high-rate signal is split into multiple lower-rate streams and each stream is transmitted from a different transmit antenna in the same frequency channel. Third, nn diversity methods, a single stream is transmitted from each of the transmit antennas with full or near orthogonal coding. Diversity coding exploits the independent fading in the multiple antenna links to enhance signal diversity.

To date, most MIMO wireless access points (e.g. those employing 802.11n) utilize external rod type antennas. These antennas are low cost, but are neither typically broadband nor low-profile because the coverage pattern of such antennas is omni-directional, approximately perpendicular to the axis along which the rod is located. As such, a ceiling-mounted access point requires its rod antennas to point toward the floor, in order to provide the requisite omni-directional coverage.

Another type of antenna which is often employed at small cell sites or in some Wi-Fi deployments, is that of a resonant patch antenna. Such antennas are planar in form, which overcomes the profile issue of rod antennas and are also typically low cost, however they are still, in general, narrow-band in nature and hence are suitable only for single-band systems (e.g. Wi-Fi only or WCDMA only and not both, in a single design). It is possible to increase the complexity of a patch antenna in order to achieve a broader bandwidth, however the main methods by which this is achieved, such as utilizing an aperture-coupled, stacked-patch arrangement, greatly increase complexity and the precision/difficulty of the manufacturing process, while also relying upon expensive low-loss dielectric materials in order to achieve a reasonable gain and efficiency.

### BRIEF DESCRIPTION OF THE DRAWINGS

The following descriptions should not be considered limiting in any way. With reference to the accompanying drawings, like elements are numbered alike:

FIG. 1 is block diagram of an typical MIMO antenna with rod antenna elements according to one embodiment;

FIG. 2 is block diagram of an typical MIMO antenna with rod antenna elements according to another embodiment;

FIG. 3 is block diagram of an typical MIMO antenna with patch antenna elements according to one embodiment;

FIG. 4 is block diagram of an typical MIMO antenna with patch antenna elements according to another embodiment;

FIG. 5 is graphs of the frequency response of a MIMO antenna without a magneto-dielectric element; and

FIG. 6 is graphs of the frequency response of a MIMO antenna with a magneto-dielectric element.

### DETAILED DESCRIPTION

A detailed description of one or more embodiments of the disclosed system, apparatus, and method are presented herein by way of exemplification and not limitation with reference to the Figures.

Embodiments disclosed herein provide a MIMO antenna having reduced coupling between the individual antennas. While the discussion below is directed to a 2×2 antenna, it shall be understood that the teachings may be applied to any number inputs/outputs such as, for examples, 2×2, 3×3, or 4×4 MIMO. In some embodiments, the antenna system may be capable of being housed in a small, low-profile structure. The disclosed embodiments may also meet normal requirements placed upon most antenna products of this type still apply; requirements such as: high gain, low cost and ease of manufacturing, for example.

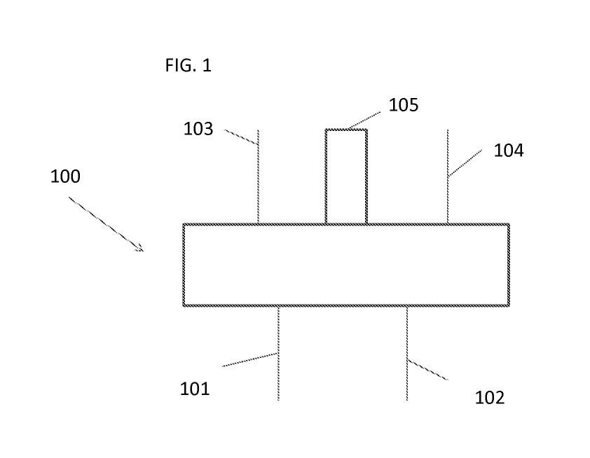

With reference to FIG. 1 a simplified diagram of a 2×2 MIMO antenna 100 is depicted. The MIMO antenna 100 includes first and second ports 101, 102 respectively. Each of ports 101, 102 may be an input/output port and is coupled to respective antenna element 103, 104. While illustrated as rod antennas, it shall be understood that the antenna elements 103, 104 could be any type of antenna element including, but not limited to, patch, rod, or the like.

In operation, so-called S-parameters describe the input-output relationship between ports 101, 102. For instance, if port 101 is called port 1 and port 102 is called port 2, then S12 represents the power transferred from port 2 to port 1 and S21 represents the power transferred from Port 1 to Port 2. Further, S11 is the reflected power (e.g., return loss) received back at port 101 when in input signal is provided to it. Ideally, S11 would be 0 (e.g., -infinity dB). However, some of the power provided to the antenna 103 is reflected back just due to construction of the antenna. Another source of energy that may appear to be reflected power but is not exists when due to S12. That is, if antenna element 104 is not decoupled from antenna element 103, a portion of the signal transmitted by antenna element 104 may be received by antenna element 103 and appear as reflected power (S11) from antenna 103 at port 101. Embodiments disclosed herein may reduce or eliminate the coupling between the antenna elements (e.g., elements 103, 104) in a MIMO system. This may be accomplished, for example, by placing a magneto-dielectric between the antennas. In one embodiment, the magneto-dielectric 105 may have real and imaginary permittivities (ε′ and ε″) of 9 and 0.015 and real and imaginary permeability (μ′ and μ″) of 9 and 0.016. Of course other values may be used.

As illustrated in FIG. 1, the magneto-dielectric 105 may be formed of a single sheet that is located between the antennas 103, 104. The size and thickness of the magneto-dielectric 105 may be varied to suit the particular implantation.

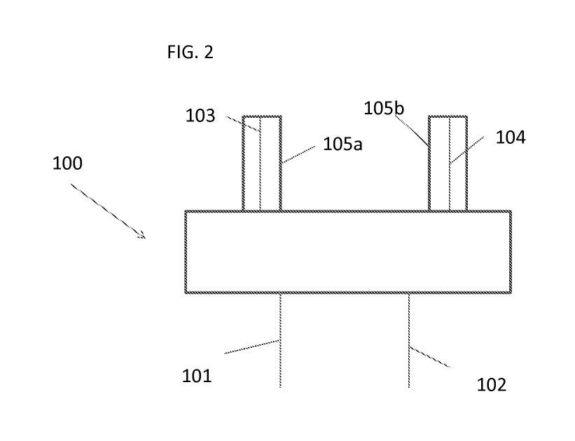

In another embodiment, and as illustrated in FIG. 2, one or both of the antenna elements 103, 104 may include a magneto-dielectric 105a, 105b, respectively, surrounding it.

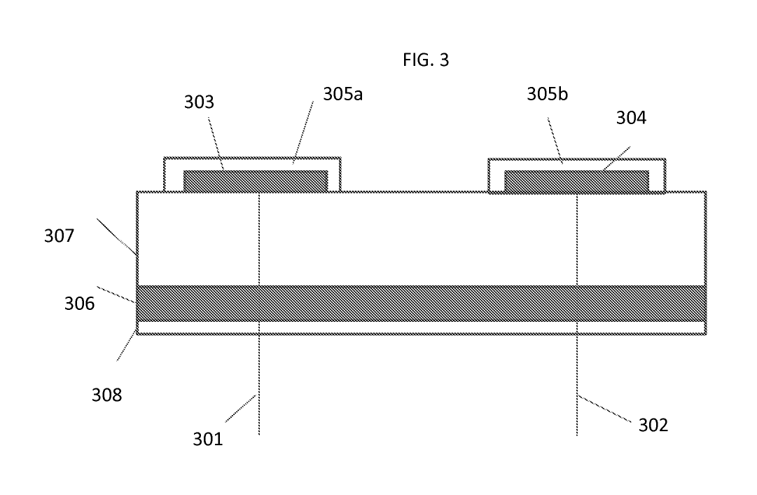

In another embodiment, the antenna elements maybe patch antennas. An example of such an embodiment is shown in FIG. 3. The MIMO antenna 300 of this embodiment includes ports 301 and 302. The ports 301, 302 may be electrically coupled to respective patch antenna element 303, 304. The MIMO antenna 300 of this embodiment (as well as all other embodiments) may include a ground plane 306 separated from the patch antenna elements 303, 304 by a dielectric layer 307. Each of the patch antennas elements 303, 304 may be formed of any type of metallic material including copper. Magneto-dielectric cover plates 305a, 305b cover the patch antenna elements 303, 304, respectively.

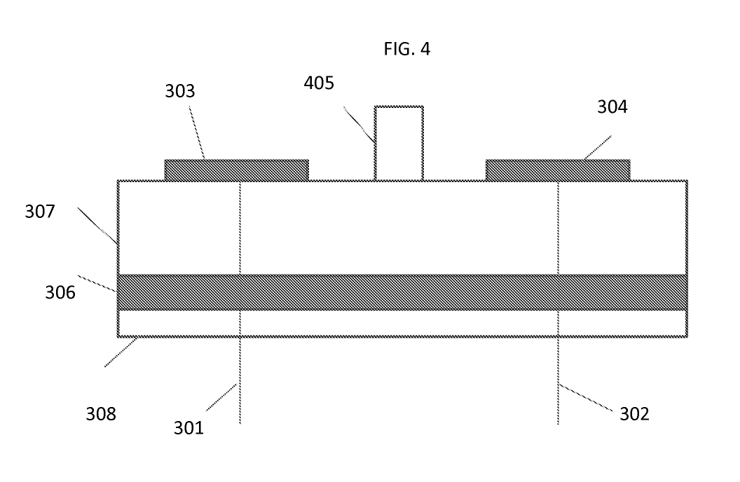

In an alternative embodiment, and as shown in FIG. 4 a magneto-dielectric 405 may be formed of a single sheet that is located between the antennas 303, 304. The size and thickness of the magneto-dielectric 405 may be varied to suit the particular implantation.

In both FIGS. 3 and 4 the patch antenna elements 303, 304 are shown as being on top of the dielectric layer 307. Of course, other arrangements are possible, including, for example, wholly or partially sinking the patch antenna elements 303, 304 into the dielectric. In both FIGS. 3 and 4, the ground plane 306 is supported by an additional layer 308 that may be formed, for example, by a rigid or semi-rigid dielectric material.

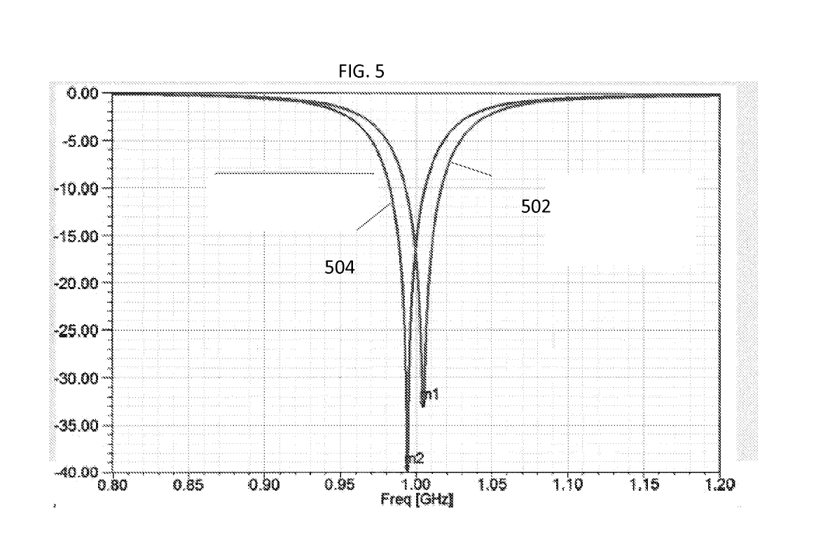

FIG. 5 shows an example frequency response of a MIMO antenna constructed as shown in FIG. 3 that does not include magneto-dielectric cover plates. The graph is includes S11 (element 502) and S22 (element 504) plotted with respect to frequency. In this example, the patch antenna elements 303 and 304 are 3.4×4.4 cm and the ground plane has dimensions of 4.6×8.8 cm and dielectric 307 has a thickness of 0.5 mm with real and imaginary permittivities (ε′ and ε″) of 5.7 and 0.005 and real and imaginary permeability (μ″ and μ″) of 1.8 and 0.08. The fact that S11 and S22 are not on top of each other indicates that the patches are coupled (i.e., signal from one is being received by the other and appears in S11/S22.

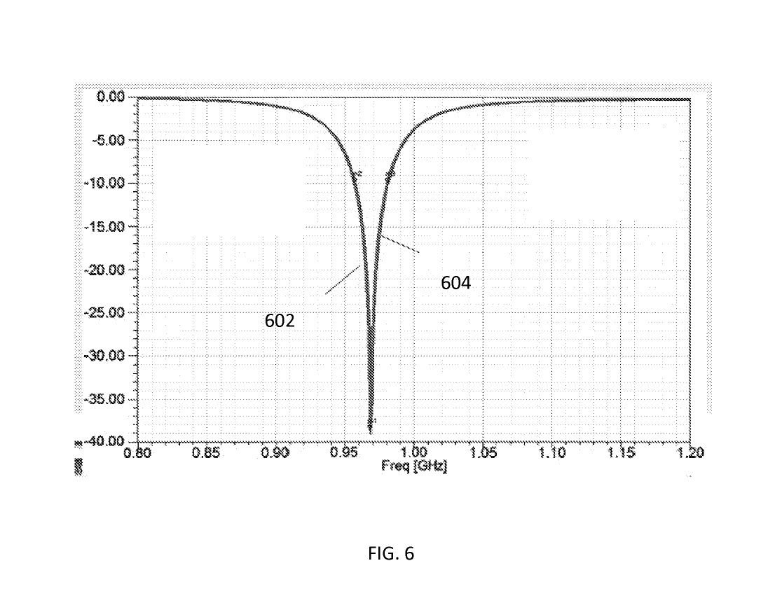

In contrast, FIG. 6 shows an example frequency response of a MIMO antenna constructed as shown in FIG. 3 that does include magneto-dielectric cover plates. The graph is includes S11 (element 602) and S22 (element 604) plotted with respect to frequency. In this example, S11 and S22 are on top of each indicating that complete or almost complete decoupling. In this example, the patch antenna elements 303, 304, the ground plane 306 and the dielectric 307 had the same dimensions and properties as above and the magneto-dielectric patches 305a, 305b had real and imaginary permittivities (ε′ and ε″) of 9 and 0.015 and real and imaginary permeability (μ′ and μ″) of 9 and 0.016.

Comparing FIGS. 5 and 6 there is a slight shift in the transmission frequency of the patch antennas. This may be adjusted by one of skill in the art to meet the particular situation.

It shall be understood that all of the devices shown in FIGS. 1-4 are simplified block diagrams. The teachings related to those drawings could be applied to any type of antenna. For example, any three dimensional metalized dielectric antenna structure could include the magneto-dielectric decoupling elements disclosed herein.

The invention is further illustrated by the following Embodiments.

Embodiment 1. An antenna assembly comprising: a dielectric layer having a upper side and a lower side; a ground plane disposed on the lower side of the dielectric layer; two antenna elements supported by and disposed on the upper side layer of the dielectric layer; and a magneto-dielectric disposed between the two antenna elements.

Embodiment 2. The antenna assembly of Embodiment 1, wherein the antenna elements are rod antennas.

Embodiment 3. The antenna assembly of Embodiment 2, wherein the magneto-dielectric is disposed on or above the upper side.

Embodiment 4. The antenna assembly of Embodiment 2, wherein the magneto-dielectric is disposed on one or both of the two antenna elements.

Embodiment 5. The antenna assembly of Embodiment 1, wherein the antenna elements are patch antennas.

Embodiment 6. The antenna assembly of Embodiment 5, wherein the magneto-dielectric is disposed on or above the upper side.

Embodiment 7. The antenna assembly of Embodiment 6, wherein the magneto-dielectric is disposed on one or both of the two antenna elements.

Embodiment 8. The antenna assembly of Embodiment 6, wherein the magneto-dielectric covers one or both of the two antenna elements.

Embodiment 9. The antenna assembly of any one or more of Embodiments 1 to 8, further comprising: at least one port for each of the one or more antenna elements.

Embodiment 10. The antenna assembly of any one or more of Embodiments 1 to 9, further comprising: a support dielectric layer supporting the ground plane.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation, or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A multi-input, multi-output (MIMO) antenna assembly comprising:
a dielectric layer having a upper side and a lower side;
a ground plane disposed on the lower side of the dielectric layer;
two antenna elements supported by and disposed on the upper side layer of the dielectric layer; and
a magneto-dielectric is disposed between the two antenna elements, the magneto-dielectric further at least partially being disposed on, covering, or surrounding one or both of the two antenna elements, and being configured to electromagnetically decouple the two antenna elements with respect to each other.

2. The antenna assembly of claim 1, wherein the antenna elements are rod antennas.

3. The antenna assembly of claim 2, wherein the magneto-dielectric is disposed on or above the upper side of the dielectric layer.

4. The antenna assembly of claim 1, wherein the antenna elements are patch antennas.

5. The antenna assembly of claim 4, wherein the magneto-dielectric is disposed on or above the upper side of the dielectric layer.

6. The antenna assembly of claim 1, further comprising:
at least one port for each of the one or more antenna elements.

7. The antenna assembly of claim 1, further comprising:
a support dielectric layer supporting the ground plane.

8. The MIMO antenna assembly of claim 1, wherein the magneto-dielectric is further configured and disposed to produce a frequency response that results in return loss signals S11 and S22 at a defined frequency being completely or substantially completely superimposed on top of each other indicative of complete or substantially complete decoupling between the two antenna elements.

9. The antenna assembly of claim 5, further comprising:
at least one port for each of the one or more antenna elements.

10. The antenna assembly of claim 5, further comprising:
a support dielectric layer supporting the ground plane.
